(19) United States
(12) Patent Application Publication
(10) Pub. No.: US 2026/0031685 A1
(43) Pub. Date: Jan. 29, 2026

(54) CONFIGURABLE COIL ELECTRIC MOTOR

(71) Applicant: Off Technologies stp, S.L., Madrid (ES)

(72) Inventor: Angel Gabriel RAMOS RAMOS, Madrid (ES)

(21) Appl. No.: 19/348,358

(22) Filed: Oct. 2, 2025

Related U.S. Application Data
(63) Continuation-in-part of application No. 16/480,475.

(30) Foreign Application Priority Data
Jan. 24, 2017 (ES) P20170053
Jul. 29, 2025 (ES) P202530704

(51) Int. Cl. H02K 11/24; H02K 13/10

(52) U.S. Cl. CPC H02K 11/24; H02K 13/10

(57) ABSTRACT

An electric motor coil can be configured according to the specific needs of each case, in order to be able to alter the torque/speed ratio the motor offers at any given moment. To this end, each winding of the coil involved in the motor is divided into a specific number of wires of the same section and length, so that these wires are grouped and insulated from each other, defining a specific number of groups, which are linked to a switching device based on a plurality of input probes and output probes to which the wires are connected. These sensors slide over the surface of a rotating drum which includes several circuits with various connection configurations for the different wires from a series of input and output terminals over which the sensors are capable of sliding.

### CROSS-REFERENCE TO RELATED APPLICATIONS AND PRIORITY

This application is a Continuation-in-Part of U.S. patent application Ser. No. 16/480,475 filed Jul. 24, 2019 which is a National Stage Entry Application of International Application No. PCT/ES2018/070044 filed Jan. 19, 2018, which claims priority from Spanish Patent Application No. P201700053 filed Jan. 24, 2017. This application additionally claims priority to Spanish Application No. P202530704 filed Jul. 29, 2025. Each of these patent applications are herein incorporated by reference in their entirety.

### OBJECT OF THE INVENTION

The present invention relates to an electric motor, in which the coil has a special structure on the basis of which it can be configured both in an inoperative situation and while the motor is operating, in order to select different working configurations supplying more torque or more speed to the motor depending on the performance required at all times.

The invention has infinite applications, such that while it has preferably been provided to be applied to the mobility of electric vehicles, it is applicable to any other field in which electric motors do not operate under a constant speed, as well as in those areas in which said motors operate as generators or energy recovery systems, which enables the braking torque of the device to be regulated, whether in the automotive sector, wind turbines, etc.

The invention focuses on the means that allow the motor winding configuration to be varied.

### BACKGROUND OF THE INVENTION

Electric motors are very common and have multiple applications, some of which relate to the mobility of electric vehicles. These applications for the most part require electric motors with very high powers for the required performance. It therefore has great cooling demands, rendering solutions which in terms of space and cost are exaggerated and have high economic costs, such that they contribute to the inefficiency of electric motors, and this becomes most evident in mobility.

It is known that in a coil the larger the cross-section of the wire (and therefore the shorter its length with respect to the same coil with a wire having a smaller cross-section), the smaller its magnetic field.

Applying this principle to electric motors, it is also known that the revolutions and torque vary depending on these parameters in the windings.

With this principle and by applying it to electric motors, it is also known that the revolutions and torque vary depending on these parameters in the windings.

Motors are manufactured today having the same power and on the same mechanical base that are specific for working at different revolutions and sacrificing torque.

This is an obstacle for applying them to mobility, for example, because if a motor with a winding having a small cross-section is selected, the motor will present low revolutions and very high torque, whereas if a winding having a large cross-section is selected, the opposite effect is obtained.

Spanish utility model U201400166 relates to a device for varying the performance of a permanent magnet electric motor and is based on control through the control box to operate the permanent magnet electric motor at different torques and speeds by means of a switching system, such that the winding thereof can be star- or delta-connected when desired. This type of system is used in many three-phase AC electric motors and is referred to as star-delta starter. It is used when it is necessary to start under load to then work at the rated speed, the relevant switching being performed by means of either mechanical or electrical automatons.

However, managing motors in that way is limited by the number of interconnections between phases and while it is true that motor output is improved, as it is completely compatible with the present invention, and where the combination of both is possible in all cases, a substantially improved global output can be achieved, which is the main objective of the present invention.

Application US20100019714 discloses a series of windings interconnected with one another by means of switches which enable increasing the number of poles, such that with this increase the low-speed torque is increased, while at the same time the number of poles is decreased as a result of an increase in speed. The number of poles is changed by making changes in the connections, which go from being connections in series to being connections in parallel, and vice versa. One way to make a change is by changing the pole configurations from delta (A) to double star (Y).

However, like in the preceding case, managing motors in that way is limited in this case by the number of poles and while it is true that motor output is improved, as it is completely compatible with the present invention, and where the combination of both is possible in all cases, a substantially improved global output can be achieved, which is the main objective of the present invention.

Finally, patent ES2356475T3 describes a motor having multiple windings, wherein the windings are different from one another given that it refers at all times to N cable types which are different from one another depending on the positions they occupy.

### DESCRIPTION OF THE INVENTION

The proposed motor solves in a fully satisfactory manner the problems set forth above based on a simple but highly effective solution specifying the means by which it is possible to obtain the switching which is precisely the objective of the present invention.

To that end and more specifically, it is provided that each winding of the coil that is used in the motor is divided into a predetermined number of identical wires, that is, they have the same cross-section and length, characterised in that said wires are grouped together and insulated from one another defining as many groups as desired, the input and output ends or poles of each group being associated with switching means, via which it is possible to connect said wires in multiple ways, either all in parallel, all in series, or in various intermediate combinations.

Accordingly, the total number of wires used in each winding must be a multiple of the number of groups to be made.

Likewise, the sum of the cross-sections of the wires will yield the result of the cross-section of the wire calculated for the desired rated power with the lowest number of turns desired to be used.

Once winding and insulation of the groups of wires has been done, switching in series or in parallel will yield as a result the cross-section of the wire and the number of turns as needed for the motor to work with the maximum efficiency required at all working times.

Thus, and by means of the actuation of the corresponding switch, regardless of its type, it is possible to utilise variations in the electromagnetic field which are produced upon changing the cross-section and length of the resulting wire in the winding, achieving a different inductance controlled by the user of the equipment through the switching control.

Therefore, the switching control for connecting the different groups of wires enables, for example, maximizing the cross-section of the resulting wire, minimizing the length thereof, in which case maximum motor revolutions would be obtained, or maximizing the length (number of turns) of said resulting wire with a minimum cross-section, in which case maximum motor torque would be obtained, with multiple intermediate possibilities being defined, depending on the number of groups into which the winding is envisaged to be divided, where the motor can thereby be optimally adapted to the specific needs of each case.

According to an additional object of the invention, the switching means are provided in a rotating device comprising a drum whose surface is divided into as many transverse sectors as there are connection configurations, with a separate and independent electrical circuit being defined for each sector for connecting the wires of each of the three motor coils.

To this end, each circuit will have a series of input contact terminals and a series of output contact terminals, which feed the intermediate connection circuit.

More specifically, the input contact terminals will be aligned transversely on one end of said sector of the drum, while the output contact terminals will be aligned transversely on the opposite end of the sector of the drum in which the specific connection circuit is integrated.

Tangentially to these two terminal alignments, a series of probes or brushes are established that are linked to a fixed structure, although in the case of using brushes, these could also be arranged radially or at any angle of incidence on the drum, so that these elements are connected to the input and output of the wires of each coil, specifically a first group to the input wires and a second group to the output wires.

In this way, the probes or brushes will come into contact with the terminals of the different circuits provided for in accordance with the different connections provided for each circuit as the drum rotates, sliding over these circuits until they reach the selected position, which allows these wires to be connected in as many different ways as there are circuits distributed over the surface of the drum.

This will allow everything from connecting all the wires of the same coil in parallel to connecting all of these wires in series, passing through different progressive intermediate configurations.

As for the probes, these will preferably be obtained from electrically conductive plates which, as mentioned above, are arranged tangentially to the drum and are linked to a transverse tilting shaft, like a rocker, so that their end opposite to that in contact with the drum circuits is connected to a spring that causes the tilting plate to tend at all times towards the position of contact with the circuit in question, a structure that facilitates the sliding of the drum and consequently the change in the configuration of connections. The plates will include a connection terminal to the corresponding wire of the coil in question.

Each of these probes will be properly electrically insulated from the components to which it is hinged, so that it acts solely as an electrical contactor.

These elements, as mentioned above, will be arranged in two transverse groups, one linked to the input end of the wire of the coil in question, while the second group will be linked to the output end of the wire of the coil in question, using all the wires of the three motor coils at all times.

Finally, it should be noted that, in order to prevent the two groups of feelers from interfering with each other during operation, they will be distributed with an angular phase shift in accordance with the planned separation between the two alignments of contact terminals provided for each connection circuit established on the surface of the rotating drum.

In this way, and by rotating the drum, it is possible to select between different types of connections for the wires of each coil, taking advantage of the variations in the electromagnetic field that occur when changing the section and length of the resulting wire in the winding.

Thus, by acting on the rotating drum, it is possible to select a circuit that maximises the cross-section of the resulting wire while minimising its length, in which case the maximum speed for the motor would be obtained, or to maximise the length (number of turns) of the resulting wire with a minimum cross-section, in which case the maximum torque for the motor would be obtained at lower speeds, with multiple intermediate possibilities being defined depending on the number of groups into which the winding is to be divided, thus allowing the motor to be optimally adapted to the specific requirements of each case.

The main feature of the winding described in this invention, unlike other multiple windings, is:
In this case all the windings are identical (unlike motors with start windings).
All the windings are always used.
No action is taken on the number of poles or on the interaction of the phases, so the combination thereof is compatible with these other methods for managing the motor.
The windings of each phase after being interconnected in any possible way act like a single wire, whereby its integrity is guaranteed for working at the power for which it was designed.

As mentioned above, the way to manage the motor proposed by the invention is particularly applicable in any electric vehicle in which many changes in the power delivery is required, depending on the speed, inclination of the ground, vehicle load, etc.

In parallel and as is evident, the system allows electrical generation by means of utilizing the kinetic energy recovered when the motor works as a brake or generator, such that depending on the desired retention the system can vary from abrupt retention to a smooth retention resulting in a different electrical generation, as well as multiple intermediate configurations.

The degree of retention for each specific case can thereby be optimised and the most effective electrical generation achieved, achieving a more effective utilization of the retention or braking which enables not only reducing power consumption but also the accumulation of power, increasing the autonomy of the vehicle in question.

Therefore, when going uphill, the motor will be arranged in the configuration in which greater magnetic force is generated and fewer watts are consumed, while on flat surfaces and at high speeds, the coil will be configured to obtain the maximum number of revolutions.

Switching will be managed by any electronic system that positions the motor depending on the demand and revolutions thereof, adapting the winding of the motor to the optimal configuration at all times, generating more or less force or more or less speed, thereby preventing the motor from overheating and therefore obtaining a higher output for each possibility.

The motor thus described therefore enables suitable management of the temperature thereof.

### DESCRIPTION OF THE DRAWINGS

To complement the description that follows and to aid in a better understanding of the characteristics of the invention, in accordance with a preferred example of its practical implementation, a set of drawings is included as an integral part of this description, in which the following is represented for illustrative and non-limiting purposes:

FIG. 1 shows a diagram of four possible configurations and the results that are obtained depending on same, and offering an electric motor with a configurable coil carried out according to the object of the present invention, specifically in the present example a three-phase permanent magnet synchronous DC motor controlled by an electronic control box.

FIG. 2 shows a diagram of the connections made by the control box or switching means that will be used in the motor for the configuration (C1) shown in FIG. 1, specifically corresponding to the configuration in which it is possible to obtain the maximum speed of the motor.

FIG. 3 shows a diagram of the connections made by the control box or switching means that will be used in the motor for the configuration (C2) shown in FIG. 1.

FIG. 4 shows a diagram of the connections made by the control box or switching means that will be used in the motor for the configuration (C3) shown in FIG. 1.

FIG. 5 finally shows a diagram of the connections made by the control box or switching means that will be used in the motor for the configuration (C4) shown in FIG. 1, specifically corresponding with the configuration in which it is possible to obtain the maximum torque of the motor.

FIG. 6 shows a perspective view of the switching means provided for a configurable coil electric motor made in accordance with the object of the invention, in which three coils are involved, each divided into six wires, which can be connected in different configurations.

FIG. 7 shows a different anterolateral perspective view of the assembly shown in FIG. 6.

FIG. 8 shows a detail of the rotating drum that is part of the mechanism in FIGS. 6 and 7, at the level of the connection circuit of the wires of the three coils, which in this circuit are connected in parallel for each coil, with the three coils connected to each other in a star configuration.

FIG. 9 Shows a detail of the rotating drum that participates in the mechanism of FIGS. 6 and 7, at the level of the connection circuit of the wires of the three motor coils, which from that circuit are connected in a series/parallel combination, in which the wires are connected in parallel in groups of three, to connect those groups in series and finally connect the three coils to each other in a star configuration.

FIG. 10 Shows a detail of the rotating drum that participates in the mechanism of FIGS. 6 and 7, at the level of the connection circuit of the wires of the three motor coils, which from said circuit are connected in a series/parallel combination, in which the wires are connected in parallel in pairs, to connect said groups in series and finally connect the three coils to each other in a star configuration.

FIG. 11 shows a detail of the rotating drum that participates in the mechanism of FIGS. 6 and 7, at the level of the connection circuit of the wires of the three motor coils, which from that circuit are connected in series, to finally connect the three coils to each other in a star configuration.

FIG. 12 shows a perspective view of the electric motor and the connection wires of its three coils to the switching mechanism in FIGS. 6 to 11.

FIG. 13 shows a schematic representation and profile of the selective mode of operation of the sensors on the different circuits provided in the rotating drum.

### PREFERRED IMPLEMENTATION OF THE INVENTION

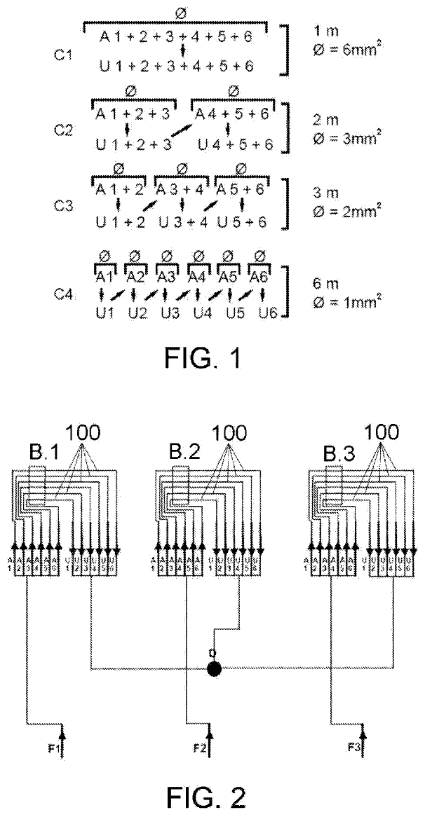

According to the embodiments shown in FIGS. 1 to 5, a motor based on the motor of the invention, specifically a three-phase permanent magnet synchronous DC motor controlled by an electronic control box which controls switching is described below in view of the mentioned drawings and in a merely exemplary and obviously non-limiting manner.

For each of the phases, 6 wires (100) of 1 meter in length and having a cross-section of 1 mm² for each wire are wound on the core, said wires being duly insulated and finished at their ends with the corresponding input and output torques (A1, A2, A3, A4, A5, A6, U1, U2, U3, U4, U5 and U6) associated with switching means, in this case controlled by an electronic control box.

Based on the management that the control box is able to carry out in relation to the connections between the input and output torques of said wires (100), the configuration of each coil B1, B2, B3, and accordingly of the motor can change considerably and thus adapt to the specific needs of each case.

Therefore, according to the first configuration (C1) provided, shown in FIGS. 1 and 2, if all the inputs A1 to A6 are connected in parallel, and if the complementary outputs U1 to U6 are connected in parallel, a coil of 1 meter and having a cross-section of 6 mm² is obtained, corresponding with the sum of the cross-section of all the wires (100) as they are connected in parallel.

This configuration enables the maximum turning speed of the motor to be obtained.

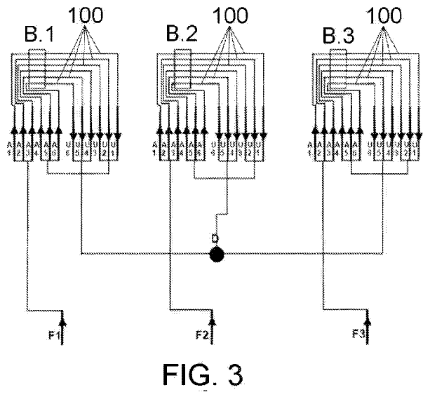

In turn, and according to the second configuration (C2) provided, shown in FIG. 3, connecting in parallel the inputs A1 to A3 and outputs U1 to U3, as well as on the other hand connecting in parallel the inputs A4 to A6 and outputs U4 to U6, and connecting in series these two previously obtained subgroups, a coil of 2 m and having a cross-section of 3 mm² is achieved, which will enable the motor to offer a higher torque than the preceding configuration, at the expense of a lower speed.

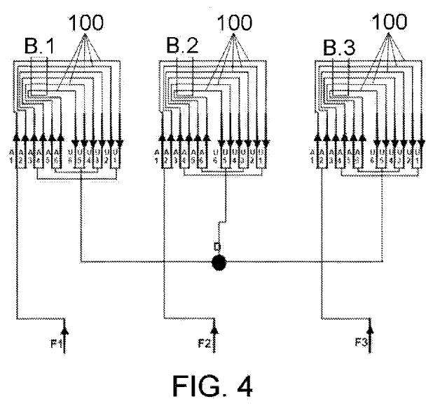

According to the third configuration (C3) provided in FIG. 4, the inputs and outputs of the wires (100) can be connected in parallel in twos, and these subgroups in turn can be connected to one another in series, so a coil of 3 m in length and having a cross-section of 2 mm² would be obtained, which will enable the motor to offer a higher torque than the preceding configuration, at the expense of a lower speed.

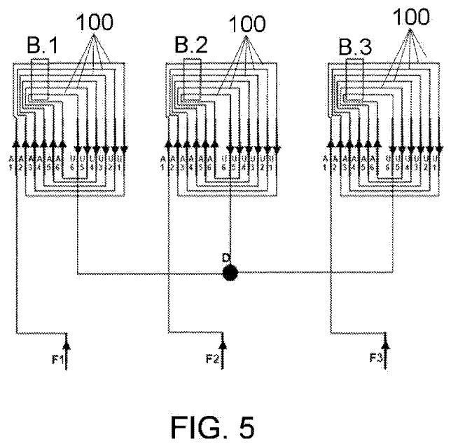

Finally and according to the fourth configuration (C4) provided in the example, shown in FIG. 5, if all the wires (100) are connected in series through their terminals (A/U), it results in a coil of 6 m in length and having a cross-section of 1 mm², and in this configuration the motor enables the maximum torque to be offered.

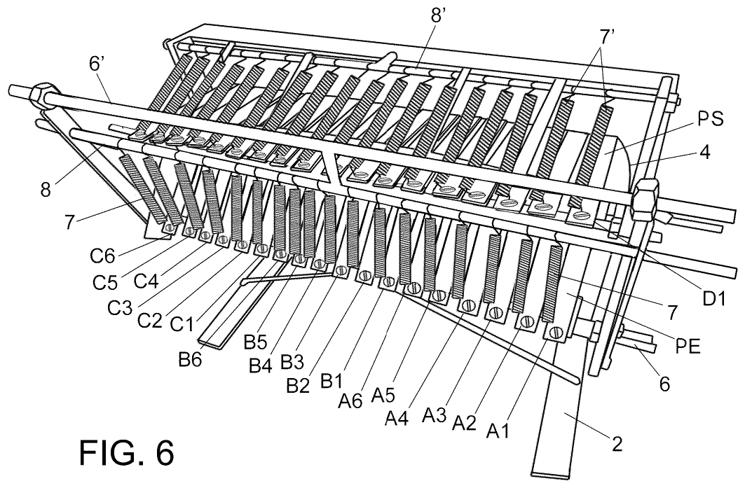

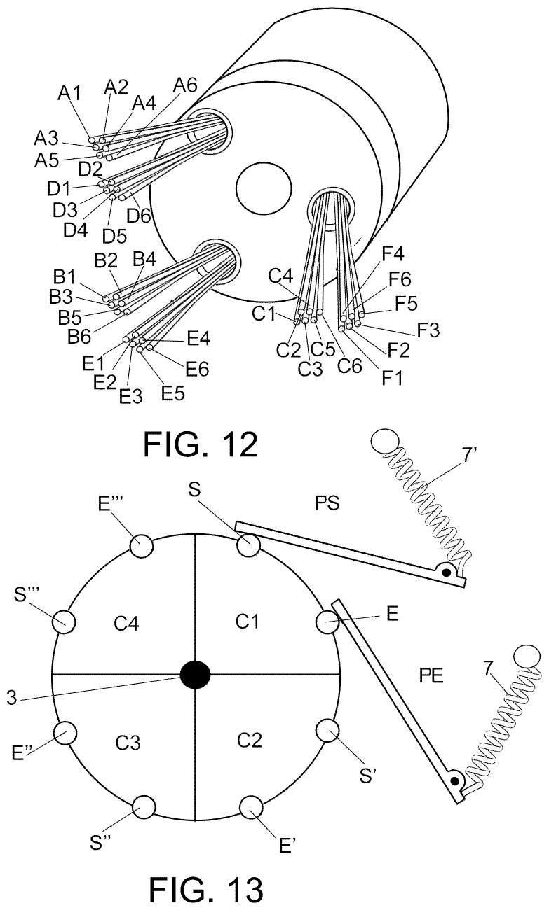

According to the embodiments shown in FIGS. 6 to 13, and in particular FIG. 12, by way of example only, the starting point was a three-phase, permanent magnet, direct current synchronous electric motor (1), in which the windings of each of its three coils associated with the respective phases were divided into six wires, each of which will be associated with an input pair (A1 to A6), (B1 to B6), (C1 to C6) and an output pair (D1 to D6), (E1 to E6), (F1 to F6), thus defining six inputs and six outputs for each coil.

These pairs are connected to a switching device, as shown in FIGS. 6 to 11.

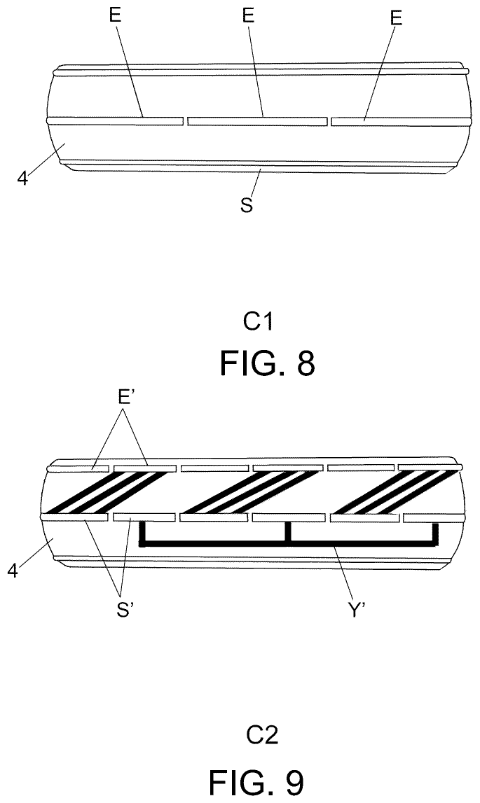

More specifically, the switching device includes a frame (2) in which a motorised shaft (3) is integrated, which controls the angular displacement of a rotating drum (4) whose surface is divided into as many transverse sectors as there are connection configurations provided for, in this example four configurations C1 to C4, shown in FIGS. 8 to 11.

To this end, a separate and independent electrical circuit is defined in each of these sectors, allowing the wires of each of the three motor coils to be connected in different ways.

In this regard, for each circuit, a series of input contact terminals and a series of output contact terminals will be defined, connected via an intermediate connection circuit.

More specifically, the input contact terminals will be aligned transversely on one end of said sector of the drum, while the output contact terminals will be aligned transversely on the opposite end of the sector of the drum in which the specific connection circuit is integrated.

As mentioned above, tangentially to these two rows of terminals, there are a series of feeler or brushes that are connected to the frame (2), specifically two alignments of probes or brushes, one alignment of input probes (PE) and one alignment of output probes (PS), as many as the pairs of inputs and outputs provided in the motor winding, in this specific case 18 input probes (PE) and 18 output probes (PS).

These sensors will include connection means for the input pairs (A1 to A6), (B1 to B6), (C1 to C6) and output pairs (D1 to D6), (E1 to E6), (F1 to F6) of the motor winding to which they are connected.

The sensors or brushes on the rotating drum will come into contact with the input contact terminals (E) and the output contact terminals(S) of the different circuits provided in accordance with the different connections provided for each circuit, sliding over these circuits until they reach the selected position, which allows these wires to be connected in as many different ways as there are circuits distributed over the surface of the drum.

As an example, in the drum circuit shown in FIG. 8, in this C1 configuration, three input terminals (E) are established, with a width 6 times that of the probes, which allows the input wires to be connected in parallel for each of the motor windings, defining a single output terminal(S), with a width corresponding to the entire set of output probes, which connects the three phases in a star configuration.

Moving on now to configuration C2, shown in FIG. 9, in a second circuit for the rotating drum (4), it has been provided that both the input terminals (E′) and the output terminals (S′) have a width three times the width of the input and output probes, so that three of the six wires of each phase are connected in parallel, and these in series with the other three remaining wires through an intermediate connection circuit (5′) that links some terminals to others, so that finally, once these elements are connected in series, their outputs are connected through a star connection circuit (Y′).

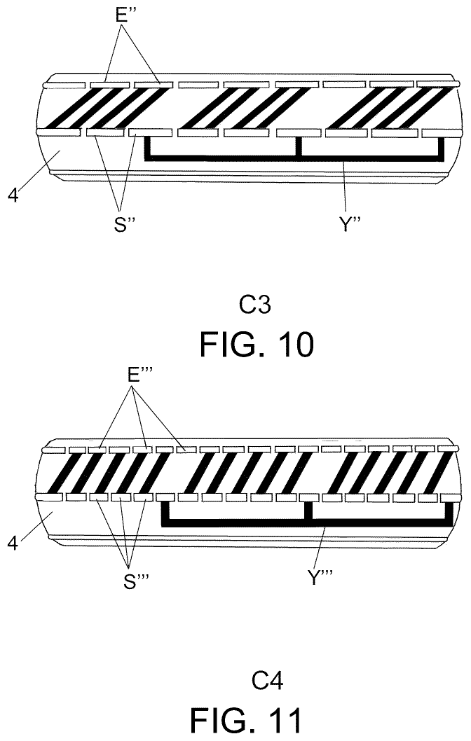

Moving on to configuration C3, shown in FIG. 10, in a third circuit for the rotating drum (4), it has been provided that both the input terminals (E″) and the output terminals (S″) have a width twice that of the input and output probes so that two of the six wires of each phase are connected in parallel, and these in series with the other two remaining pairs of wires through an intermediate connection circuit (5″) that links some terminals to others, so that finally, once these three pairs of wires are connected in series, their outputs are connected through a star connection circuit (Y″).

Finally, in the C4 configuration shown in FIG. 11, in a fourth circuit for the rotating drum (4), it is envisaged that both the input terminals (E″) and the output terminals (S″) will have a width in accordance with the width of the input and output sensors so that the six wires of each phase are connected in series through an intermediate connection circuit (5″) that links some terminals to others, so that finally, once the six wires of each phase are connected in series, their outputs are connected through a star connection circuit (Y″).

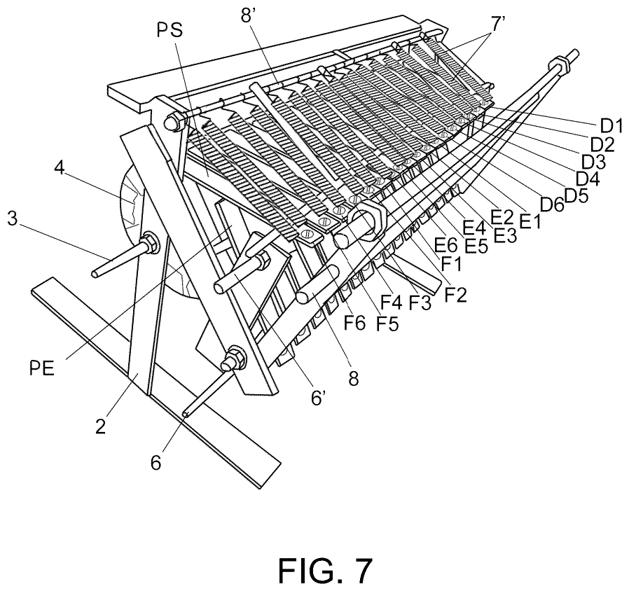

Returning to FIGS. 6 and 7, with regard to the input and output probes (PE) and (PS), these will preferably be obtained from electrically conductive plates which, as mentioned above, are arranged tangentially to the drum and are linked to a transverse tilting shaft (6-6′) in the manner of a rocker, so that their end opposite that in contact with the drum circuits is linked to at least one spring (7-7′) connected at its other end to a transverse bar (8-8′) provided in the frame (2), which causes said tilting plate to tend at all times towards the position of contact against the terminals of the drum, a structure which, as mentioned above, facilitates the sliding of the drum and consequently the change in the configuration of connections, although brushes could be used without affecting the essence of the invention.

In either case, the plates or brushes include connection means for the input pairs (A1 to A6), (B1 to B6), (C1 to C6) and output pairs (D1 to D6), (E1 to E6), (F1 to F6) of the motor winding to which they are connected.

As can be seen in FIG. 7, these elements are arranged in two transverse and tangential groups, distributed with an angular offset according to the intended separation between the two alignments of input and output terminals provided for each connection circuit established on the surface of the rotating drum.

Based on this structure, the controlled rotation of the drum allows different types of connections to be selected for the wires of each coil, taking advantage of the variations in the electromagnetic field that occur when changing the section and length of the resulting wire in the winding.

More specifically, when configuration C1, shown in FIG. 8, is selected on the rotating drum, all the wires are connected in parallel, a configuration that allows the maximum motor speed to be obtained.

Configurations C2 and C3, on the other hand, provide intermediate configurations in which the total length of each coil winding increases in contrast to its section, increasing torque at the expense of lower speed, so that finally, in position C4, in which the wires are all in series for each phase, maximum torque is achieved at lower engine speeds.

This optimises motor performance at all times, depending on the specific requirements of each case.

1. A configurable coil electric motor, which is of the type whose windings are divided into a certain number of wires of the same cross-section and length that are grouped and insulated from each other, with the ends of said groups of wires connected to input pairs and output pairs, characterized in that the input and output pairs are connected to a switching device, involving a frame in which a motorized shaft is integrated, controlling the angular displacement of a rotating drum whose surface is divided into as many transverse sectors as there are connection configurations provided for the wires of the motor coils, with the particularity that each of the sectors of the rotating drum includes an independent electrical circuit, in which a series of input contact terminals and a series of output contact terminals are established, connected via an intermediate connection circuit, terminals on which a series of probes or brushes linked to the frame are capable of coming into contact, to which the input pairs and the output pairs, each intermediate connection circuit defining selective connection of the wires of each winding according to different series/parallel configurations and combinations thereof.

2. The configurable coil electric motor, according to claim 1, wherein the input contact terminals are arranged transversely on one of the ends of the drum sector in which the intermediate connection circuit is established, while the output contact terminals are arranged transversely on the opposite end of said sector.

3. The configurable coil electric motor, according to claim 1, wherein the sensors or brushes are distributed in two parallel alignments tangential to the rotating drum, with the alignments angularly offset from each other; one alignment of input sensors and one alignment of output sensors, with as many sensors participating as there are input pairs and output pairs provided for in the motor winding.

4. The configurable electric coil motor, according to any of the previous claims, where the input and output sensors and are obtained from plates of electrically conductive material, which are arranged tangentially to the drum and are linked to a transverse rocker shaft, acting as a rocker, so that its end opposite that in contact with the terminals of the drum circuits is linked to at least one spring linked at its other end to a transverse bar provided in the frame, which causes said rocker plate to tend at all times towards the position of contact against the terminals of the drum.

5. The configurable coil electric motor, according to claim 1, where each of the three coils associated with the respective phases of the motor are divided into six wires, each of which is associated with an input pair and an output pair, establishing 18 input sensors and 18 output sensors in the switching device, with provision for three input terminals to be established in one of the sectors of the rotating drum, three input terminals are established, with a width 6 times that of the sensors, so that they connect the input wires in parallel for each of the motor windings, defining a single output terminal, with a width corresponding to the entire set of output sensors, which connects the three phases in a star configuration.

6. The configurable coil electric motor, according to claim 1, wherein each of the three coils associated with respective phases of the motor are divided into six wires, each of which is associated with an input pair and an output pair, establishing 18 input sensors and 18 output sensors in the switching device 18, with a series of input terminals and output terminals being provided in one of the sectors of the rotating drum with a width three times that of the input and output sensors, so that three of the six wires of each phase are connected in parallel, and these in series with the other three remaining wires through an intermediate connection circuit that links some terminals to others, their outputs being connected through a star connection circuit.

7. The configurable coil electric motor, according to claim 1, wherein each of the three coils associated with respective phases of the motor are divided into six wires, each of which is associated with an input pair and an output pair, with 18 input sensors and 18 output sensors being established in the switching device, it being provided that in one of the sectors of the rotating drum, a series of input terminals and output terminals are established, which are twice as wide as the input and output sensors, so that two of the six wires in each phase are connected in parallel, and these are connected in series with the other two remaining pairs of wires via an intermediate connection circuit that links some terminals to others, their outputs being connected via a star connection circuit.

8. The configurable coil electric motor, according to claim 1, wherein each of the three coils associated with respective phases of the motor are divided into six wires, each of which is associated with an input pair and an output pair, establishing 18 input sensors and 18 output sensors in the switching device 18, with a series of input terminals and output terminals are provided, which have a width corresponding to the width of the input and output sensors so that the six wires of each phase are connected in series through an intermediate connection circuit that links some terminals to others, their outputs being connected through a star connection circuit.
